(19) United States
(12) Patent Application Publication
(10) Pub. No.: US 2007/0169034 A1
(43) Pub. Date: Jul. 19, 2007

(54) SYSTEM AND METHOD FOR GENERATING A MEASURING PROGRAM

(75) Inventors: CHIH-KUANG CHANG, Tu-Cheng,Taipei Hsien (TW); LI JIANG, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/552,974

(22) Filed: Oct. 26, 2006

(30) Foreign Application Priority Data
Nov. 10, 2005 (CN) 200510101187.5

(51) Int. Cl. G06F 9/45; G06F 9/44

(52) U.S. Cl. 717/140; 717/110

(57) ABSTRACT

An exemplary for generating a measuring program is disclosed. The method includes: editing a measuring program source code generated by an image measuring machine after completing a full measuring cycle on a workpiece; detecting whether there are any measuring program errors during the editing process; identifying and displaying a location where the measuring program errors occur and reporting reasons of the errors correspondingly, and returning to edit the measuring program source code if the measuring program errors have occurred; saving the edited measuring program source code in a source code file; and compiling the source code file into a measuring program executable for a computer. A related system is also disclosed.

### BACKGROUND OF THE INVENTION

1. Field of the Invention

The present invention is generally related to systems and methods for generating a measuring program, and particularly to a system and method for generating a measuring program for measuring workpieces of a same type.

2. Description of related art

In modern manufacturing processes, it is generally desirable to have as much control and automation as possible. In order to improve the manufacturing processes as much as possible, and to posses a great control as possible, large amounts of information are collected and analyzed that allow for a refinement of the manufacturing process and improving quality control.

For example, before a type of workpiece is mass produced, at least one workpiece of the same type needs to be measured manually in order to inspect the quality of the workpiece—an important factor for keeping an enterprise competitive. Then, an operator watches the measuring procedures, and analyzes the sizes of the workpiece. If the sizes of the measured workpiece are good, a same type of workpieces would be mass produced manually.

Therefore, what is needed is a system and method for generating a measuring program for measuring workpieces of a same type intelligently.

### SUMMARY OF THE INVENTION

A system for generating a measuring program configured in a computer is disclosed. The system mainly includes a source code editing and generating module, a determining module, an error reporting module, a saving module, and a compiling module. The source code editing and generating module is configured for editing measuring program source code generated by an image measuring machine after completing a full measuring cycle on a workpiece, and for modifying measuring program errors. The determining module is configured for determining whether there are any measuring program errors during the editing process. The error reporting module is configured for identifying and displaying a location where the measuring program errors occur and reporting reasons of the errors correspondingly if there are measuring program errors during the editing process. The saving module is configured for saving the edited measuring program source code in a source code file. The compiling module is configured for compiling the source code file into a measuring program executable for the computer.

A related method for generating a measuring program is disclosed. The method includes: editing a measuring program source code generated by an image measuring machine after completing a full measuring cycle on the workpiece; detecting whether there are any measuring program errors during the editing process; identifying and displaying a location where the measuring program errors occur and reporting reasons of the errors correspondingly, and returning to edit the measuring program source code if the measuring program errors have occurred; saving the edited measuring program source code in a source code file; and compiling the source code file into a measuring program executable for a computer.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of an application environment of a system for generating a measuring program in accordance with one embodiment;

FIG. 2 is a schematic diagram of software function modules of the system of FIG. 1; and

FIG. 3 is a flowchart of a preferred method for generating a measuring program in accordance with another preferred embodiment.

### DETAILED DESCRIPTION OF THE INVENTION

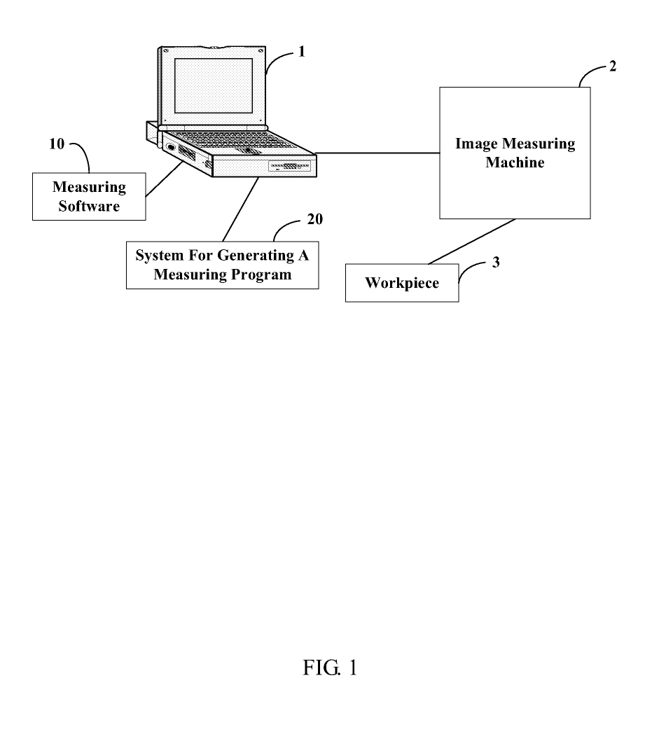

FIG. 1 is a schematic diagram of an application environment of a system for generating a measuring program (hereinafter “the system 20”), in accordance with one embodiment. The application environment of the system 20 mainly includes a computer 1, an image measuring machine 2, and at least one workpiece 3. The computer 1 may include measuring software 10 that is configured for measuring dimensions of the workpiece 3. The computer 1 is electronically connected with the image measuring machine 2, and the computer 1 may be a desktop computer, a laptop computer, a notebook, or any other suitable type of computing device. The image measuring machine 2 has a measuring unit that is movable in a three-dimensional space, and supports a visual sensor having a camera and a light source.

The system 20 is configured in the computer 1, and configured for (i.e., structured and arranged for) generating a measuring program by utilizing a Visual Basic (VB) editor. The system 20 is configured with several measuring functions, such as functions for controlling an electric machine and a light source of the image measuring machine 2. Variables and function calls in a measuring program source code of the measuring program are highlighted with different colors, and each of the variables has been set a data type.

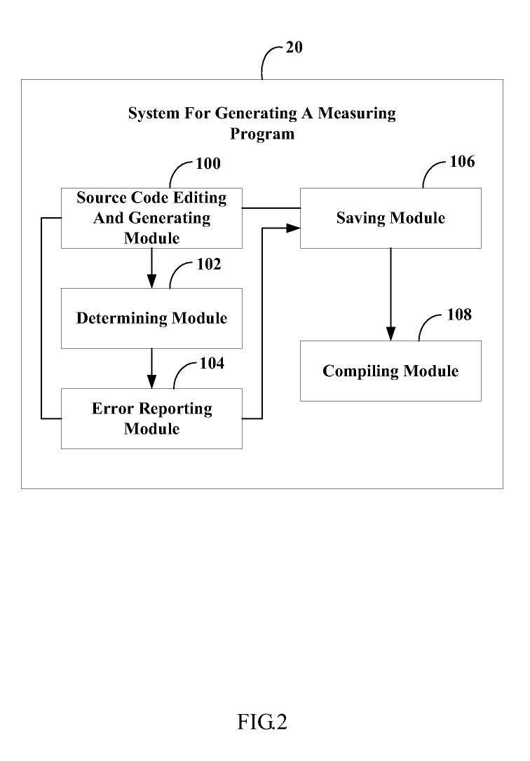

FIG. 2 is a schematic diagram of software function modules of the system 20. The system 20 includes a source code editing and generating module 100, a determining module 102, an error reporting module 104, a saving module 106, and a compiling module 108.

The source code editing and generating module 100 is configured for recording measuring procedures. The measuring procedures are generated when the image measuring machine 2 completes a full measuring cycle on the workpiece 3 by utilizing the measuring software 10. The source code editing and generating module 100 is further configured for editing the measuring program source code according to the measuring procedures with the VB editor. The measuring program source code may be structured in accordance to the VB syntax. When a user wants to define a new variable during the editing process, the source code editing and generating module 100 can automatically display various data types of the new variable, a user definition of the new variable, and other related attributes.

The measuring procedures are performed corresponding to the measuring cycle and related measuring information. The measuring information may include a position of the measuring unit of the image measuring machine 2, configuring a type of the light source of the image measuring machine 2, configuring a luminous flux of the light source, configuring an operating speed of the measuring unit of the image measuring machine 2, and other related operational information. The related operational information mainly includes a find edge tool, a focus tool, measuring elements, constructive elements, and coordinates.

The determining module 102 is configured for detecting whether there are any measuring program errors when the source code editing and generating module 100 edits the measuring program source code. The measuring program errors include three types of errors, data type errors of the measuring program source code, syntax errors of the measuring program source code, and runtime errors while executing the measuring program. The determining module 102 is further configured for detecting whether the source code editing and generating module 100 has finished editing the measuring program source code.

The error reporting module 104 is configured for identifying and displaying a location where the measuring program errors occur, and reporting reasons of the errors to the user correspondingly.

The saving module 106 is configured for saving the measuring program source code edited by the source code editing and generating module 100 in a source code file when the source code editing and generating module 100 finishes editing the measuring program source code.

The compiling module 108 is configured for compiling the source code file into a measuring program that is executable by the computer 1. The measuring program can invoke basic commands of a basic command library to measure other workpieces of the same type of the workpiece 3. The basic command library is configured in the computer 1, which is edited with the VB editor. The basic commands of the basic command library may include motion commands, speed commands, acceleration commands, and finishing commands. The motion commands are used for controlling the image measuring machine 2 to measure the workpiece 3. The speed commands and acceleration commands are used for controlling the operating speed of the measuring unit. The finishing commands are used for stopping operating the image measuring machine 2.

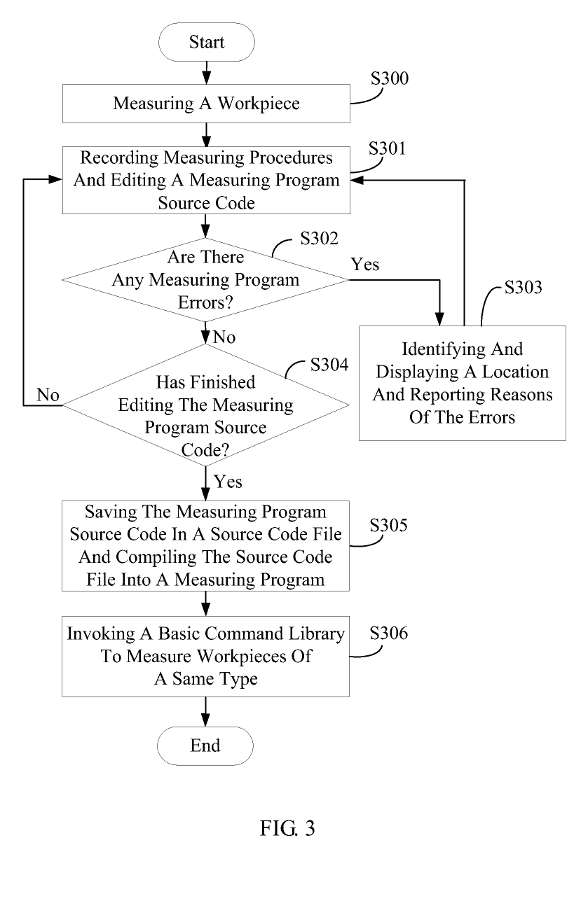

FIG. 3 is a flowchart of a preferred method for generating a measuring program in accordance with another preferred embodiment. In step S300, the image measuring machine 2 is utilized for completing the full measuring cycle on the workpiece 3 by executing the measuring software 10.

In step S301, the source code editing and generating module 100 records the measuring procedures, and edits the measuring program source code according to the measuring procedures. The measuring procedures are performed corresponding to the measuring cycle and related measuring information. The measuring information may include a position of the measuring unit of the image measuring machine 2, configuring a type of the light source of the image measuring machine 2, configuring a luminous flux of the light source, configuring an operating speed of the measuring unit, and other related operational information. The related operational information mainly includes a find edge tool, a focus tool, measuring elements, constructive elements, and coordinates.

In step S302, the determining module 102 detects whether there are any measuring program errors when the source code editing and generating module 100 edits the measuring program source code.

In step S303, if there are any measuring program errors when the source code editing and generating module 100 edits the measuring program source code, the error reporting module 104 identifies and displays the location where the measuring program errors occur and reports reasons of the errors to the user correspondingly, and the process returns to the step S301 as described above.

In step S304, if there are no measuring program errors, the determining module 102 detects whether the source code editing and generating module 100 has finished editing the measuring program source code.

In step S305, if the source code editing and generating module 100 has finished editing the measuring program source code, the saving module 106 saves all the measuring program source code in the source code file , and the compiling module 108 compiles the source code file into the measuring program that is executable for the computer 1.

In step S306, the measuring program invokes the basic commands of the basic command library to measure workpieces of the same type. The basic commands include motion commands, speed commands, acceleration commands and finishing commands.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for generating a measuring program configured in a computer, the system comprising:
a source code editing and generating module configured for editing a measuring program source code generated by an image measuring machine after completing a full measuring cycle on a workpiece, and for modifying measuring program errors;
a determining module configured for detecting whether there are any measuring program errors during the editing process;
an error reporting module configured for identifying and displaying a location where the measuring program errors occur and reporting reasons of the errors correspondingly if there are measuring program errors during the editing process;
a saving module configured for saving the edited measuring program source code in a source code file; and
a compiling module configured for compiling the source code file into a measuring program executable for the computer.

2. The system according to claim 1, wherein the measuring program is configured for measuring workpieces of a same type by invoking basic commands of a basic command library.

3. The system according to claim 2, wherein the basic commands comprise motion commands, speed commands, acceleration commands, and finishing commands.

4. The system according to claim 1, wherein the source code editing and generating module is further configured for recording measuring procedures generated by the image measuring machine after completing the full measuring cycle on the workpiece, and for editing corresponding measuring program source code according to the measuring procedures.

5. The system according to claim 4, wherein the measuring procedures are performed corresponding to the measuring cycle and related measuring information, the measuring information comprising a position of a measuring unit of the image measuring machine, configuring a type of a light source of the image measuring machine, configuring a luminous flux of the light source, configuring an operating speed of the measuring unit of the image measuring machine, a find edge tool, a focus tool, measuring elements, constructive elements, and coordinates.

6. The system according to claim 1, wherein the source code editing and generating module is further configured for showing various data types of the new variable, a user definition of the new variable, and other related attributes.

7. A method for generating a measuring program, the method comprising:
editing a measuring program source code generated by an image measuring machine after completing a full measuring cycle on a workpiece;
detecting whether there are any measuring program errors during the editing process;
identifying and displaying a location where the measuring program errors occur and reporting reasons of the errors correspondingly, and returning to edit the measuring program source code if the measuring program errors have occurred;
saving the edited measuring program source code in a source code file; and
compiling the source code file into a measuring program executable for a computer.

8. The method according to claim 7, further comprising:
invoking a basic command library; and
executing basic commands of the basic command library and all commands of the measuring program to measure workpieces of a same type.

9. The method according to claim 8, wherein the basic commands comprise motion commands, speed commands, acceleration commands and finishing commands.

10. The method according to claim 7, further comprising:
showing various data types of the new variable, a user definition of the new variable, and other related attributes if a user wants to define a new variable during the editing process.
